(19) United States
(12) Patent Application Publication
(10) Pub. No.: US 2010/0230345 A1
(43) Pub. Date: Sep. 16, 2010

(54) WATER KETTLE CAPABLE OF FILTERING IMPURITIES FROM WATER

(75) Inventor: Ming-Chang Chen, Taipei (TW)

Correspondence Address: SCHWABE, WILLIAMSON & WYATT, P.C., 1420 FIFTH, SUITE 3400, SEATTLE, WA, 98101-4010, US

(73) Assignee: CO-UNION INDUSTRY CO., LTD., Yung Kang City (TW)

(21) Appl. No.: 12/404,889

(22) Filed: Mar. 16, 2009

(51) Int. Cl. B01D 27/02

(52) U.S. Cl. 210/287

(57) ABSTRACT

A water kettle includes a kettle body having a receiving space, a cover unit, a hollow receiving member, and a filtering unit. The cover unit includes a cover body mounted on the kettle body, and a valve movable relative to the cover body for controlling flow of water from a water outlet in the cover body. The receiving member is attached to the cover body, and includes a filtering space in fluid communication with the water outlet, and a plurality of openings in fluid communication with the filtering space and the receiving space. The filtering unit is disposed within the receiving member for filtering impurities from the water flowing from the receiving space into the water outlet through the hollow receiving member.

### BACKGROUND OF THE INVENTION

1. Field of the Invention

This invention relates to a water kettle, and more particularly to a water kettle that can filter impurities from water in the water kettle.

2. Description of the Related Art

A conventional water kettle includes a kettle body having a water outlet, and a cover disposed for covering removably the water outlet and operable to control flow of water from the water outlet. Suspended substances, however, may occur in the water in the kettle body, thereby representing a health risk. Therefore, it is desirable to filter the water before it flows out of the water outlet.

### SUMMARY OF THE INVENTION

The object of this invention is to provide a water kettle that can filter impurities from the water contained therein.

According to this invention, a water kettle includes a kettle body having a receiving space, a cover unit, a hollow receiving member, and a filtering unit. The cover unit includes a cover body mounted on the kettle body, and a valve movable relative to the cover body for controlling flow of water from a water outlet in the cover body. The receiving member is attached to the cover body, and includes a filtering space in fluid communication with the water outlet, and a plurality of openings in fluid communication with the filtering space and the receiving space. The filtering unit is disposed within the receiving member for filtering impurities from the water flowing from the receiving space into the water outlet through the hollow receiving member.

### BRIEF DESCRIPTION OF THE DRAWINGS

These and other features and advantages of this invention will become apparent in the following detailed description of a preferred embodiment of this invention, with reference to the accompanying drawings, in which;

FIG. 1 is an exploded perspective view of the preferred embodiment of a water kettle according to this invention;

FIG. 2 is a fragmentary sectional view of the preferred embodiment, illustrating a vale in a sealing position; and

FIG. 3 is a view similar to FIG. 2 but illustrating the valve in an open position.

### DETAILED DESCRIPTION OF THE PREFERRED EMBODIMENT

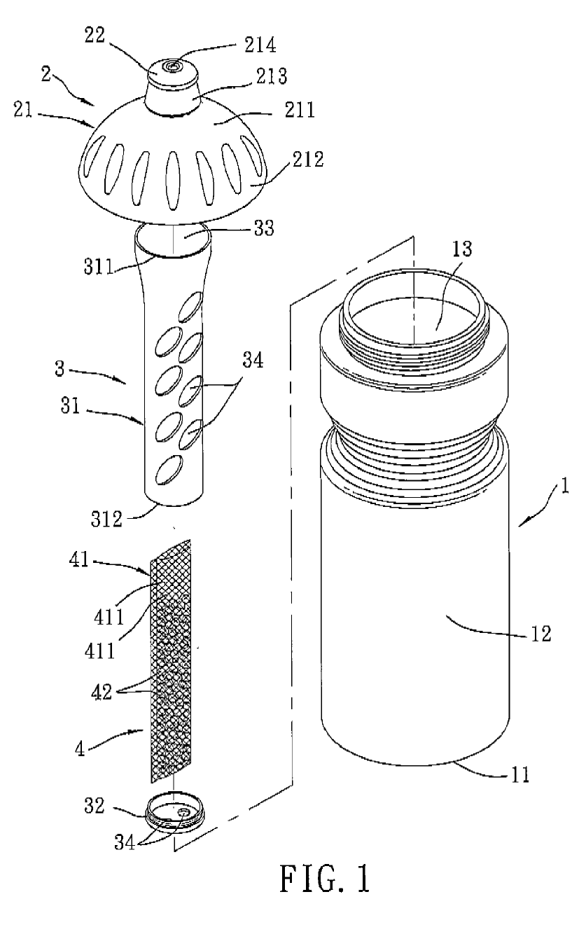

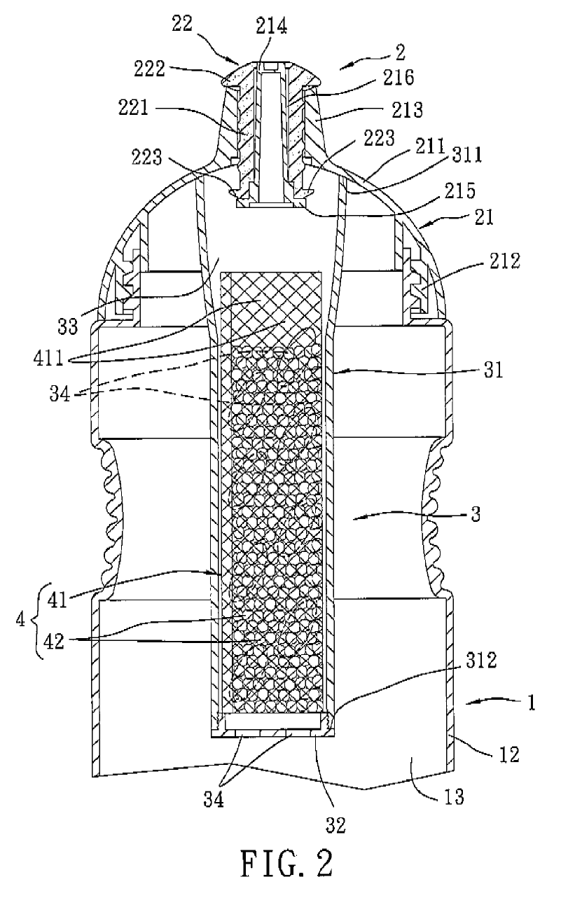

Referring to FIGS. 1 and 2, the preferred embodiment of a water kettle according to this invention includes a kettle body 1, a cover unit 2, a hollow receiving member 3, and a filtering unit 4.

The kettle body 1 has a bottom wall 11, and a surrounding wall 12 extending upwardly from the bottom wall 11. As such, the kettle body 1 has an open upper end. The bottom wall 11 cooperates with the surrounding wall 12 to define a receiving space 13 for receiving water therein.

The cover unit 2 includes a cover body 21 mounted removably on the upper end of the kettle body 1 in a known manner, and a valve 22 mounted on the cover body 21 and movable vertically relative to the cover body 21. The cover body 21 has a covering wall 211 disposed directly above the receiving chamber 13 in the kettle body 1, a body-coupling wall 212 extending downwardly from the covering wall 211 and connected removably to the surrounding wall 12 of the kettle body 1, a spout 213 extending upwardly from a central portion of the covering wall 211, a central post 214 fixed within a central portion of the spout 213, an outward flange 215 extending radially and outwardly from a lower end of the central post 214, and a water outlet 126 defined between the spout 213 and the central post 214. The central post 214 can be fixed within the spout 213 by a plurality of connecting rods (not shown) connected integrally to the covering wall 211 and the outward flange 215. Since the connecting rods are not pertinent to the claimed invention, a further description thereof will be omitted herein for the sake of brevity.

The valve 22 has an axial tubular portion 221 disposed movably within the water inlet 216, an upper stop portion 222 extending radially and outwardly from an upper end of the axial tubular portion 221 and disposed directly above the spout 213, and two bottom stop portions 223 extending from a lower end of the axial tubular portion 221 away from each other and disposed directly above the outward flange 215. The valve 22 is movable vertically relative to the cover body 21 for controlling flow of water from the water outlet 216 in the cover body 21.

The hollow receiving member 3 is attached to the covering wall 211, is disposed under the water cutlet 216, and extends into the receiving space 13. In this embodiment, the hollow receiving member 3 includes an upright central tube 31 having upper and lower ends 311, 312, an end cap 32 connected removably to the lower end 312 of the central tube 31 to define a filtering space 33 in fluid communication with the water outlet 216, and a plurality of openings 34 in fluid communication with the filtering space 33 and the receiving space 13 so as to allow for water flow between the filtering space 33 and the receiving space 13 therethrough. Two of the openings 34 are formed in the end cap 32. The remaining openings 34 are formed in the central tube 31.

The upper end 311 of the central tube 31 is connected fixedly and sealingly to a bottom surface of the covering wall 211, e.g., by high frequency heat sealing, and is disposed around the central post 214, the water outlet 216, and the valve 22. Alternatively, the central tube 31 may be connected removably to the covering wall 211. In this embodiment, the end cap 32 is connected threadedly to the lower end 312 of the central tube 31. As such, the end cap 32 can be removed from the central tube 31 so as to allow for replacement of the filtering unit 4. Alternatively, the end cap 32 may be a rubber plug that is press fitted within the lower end 312 of the central tube 31.

The filtering unit 4 is disposed within the hollow receiving member 3, and includes a net bag 41, and a plurality of filtering materials 42 received within the net bag 41 for filtering impurities from the water flowing from the receiving space 13 into the water outlet 216 through the hollowing receiving member 3. The net bag 41 has a plurality of meshes 411 sized to allow for flow of water therethrough while preventing passage of the impurities therethrough. The filtering materials 41 may be configured as active carbons or bamboo charcoals. Alternatively, the filtering materials 41 may be replaced with a carbon block that can be porous to increase the contact area between water and the carbon block to thereby promote the filtering effect.

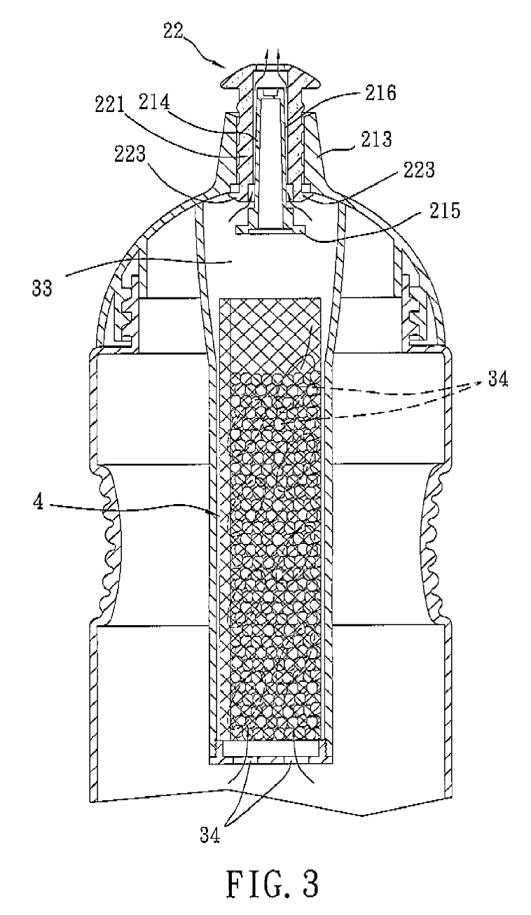

The valve 22 is movable relative to the cover body 21 between a sealing position shown in FIG. 2 and an open position shown in FIG. 3. In the sealing position, the upper stop portion 222 abuts against an upper end of the spout 213, and the bottom stop portions 223 abut against the outward flange 215. As such, the water outlet 216 is closed to prevent flow of water out of the water kettle. With particular reference to FIG. 3, when it is desired to drink the water in the water kettle, the valve 22 is moved upwardly from the sealing position to the open position to thereby separate the upper stop portion 222 and an assembly of the lower stop portions 223 from the upper end of the spout 213 and the outward flange 215, respectively. As a result, the water outlet 216 is opened to allow for flow of water out of the water kettle therethrough.

Due to the presence of the filter unit 4, the impurities can be held within the filtering space 33 when water flows out of the kettle body 1 through the water outlet 216. Thus, the object of this invention is achieved.

With this invention thus explained, it is apparent that numerous modifications and variations can be made without departing from the scope and spirit of this invention. It is therefore intended that this invention be limited only as indicated by the appended claims.

I claim:

1. A water kettle comprising:
a kettle body having a receiving space adapted for receiving water therein, and an open upper end;
a cover unit including a cover body mounted removably on said upper end of said kettle body and having a water outlet, and a valve mounted on said cover body and movable relative to said cover body for controlling flow of water from said water outlet in said cover body;
a hollow receiving member attached to and disposed under said cover body and having an upper end disposed around said water outlet, said hollow receiving member extending into said receiving space and including a filtering space in fluid communication with said water outlet, and a plurality of openings in fluid communication with said filtering space and said receiving space so as to allow for water flow between said filtering space and said receiving space therethrough; and
a filtering unit disposed within said hollow receiving member and adapted for filtering impurities from the water flowing from said receiving space into said water outlet through said hollow receiving member.

2. The water kettle as claimed in claim 1, wherein said filtering unit includes a net bag, and a plurality of filtering materials received within said net bag for filtering the impurities, said net bag having a plurality of meshes sized to allow for flow of water therethrough while preventing passage of the impurities therethrough.

3. The water kettle as claimed in claim 2, wherein said filtering materials are configured as active carbons.

4. The water kettle as claimed in claim 2, wherein said filtering materials are configured as bamboo charcoals.

5. The water kettle as claimed in claim 1, wherein said hollow receiving member further includes an upright central tube having an upper end connected fixedly and sealingly to said cover body and disposed around said valve, and an end cap connected removably to a lower end of said central tube to define said filtering space, at least one of said openings being formed in said end cap, the remaining of said openings being formed in said central tube.

6. The water kettle as claimed in claim 1, wherein said cover body of said cover unit has a covering wall disposed directly above said receiving chamber in said kettle body and connected to said hollow receiving member, a body-coupling wall extending downwardly from said covering wall and connected removably to said kettle body, a spout extending upwardly from said covering wall, a central post fixed within said spout, and an outward flange extending radially and outwardly from a lower end of said central post, said spout cooperating with said central post to define said water outlet therebetween, said valve having an axial tubular portion disposed movably within said water outlet, and two bottom stop portions extending from a lower end of said axial tubular portion away from each other and abutting against said outward flange of said cover body, said valve being movable upwardly relative to said cover body to separate said bottom stop portions of said valve from said outward flange of said cover body so as to allow for flow of water from said water outlet.

7. The water kettle as claimed in claim 1, wherein said kettle body further has a bottom wall, and a surrounding wall extending upwardly from said bottom wall and connected to said cover body, said bottom wall cooperating with said surrounding wall to define said receiving space.
